(19) United States
(12) Patent Application Publication
(10) Pub. No.: US 2026/0187157 A1
(43) Pub. Date: Jul. 2, 2026

(54) WORKLOAD COMPRESSION USING LARGE LANGUAGE MODELS

(71) Applicant: Teradata US, Inc., San Diego, CA (US)

(72) Inventor: Louis M. Burger, Escondido, CA (US)

(73) Assignee: Teradata US, Inc., San Diego, CA (US)

(21) Appl. No.: 19/007,400

(22) Filed: Dec. 31, 2024

(51) Int. Cl. G06F 16/93; G06F 16/3349

(52) U.S. Cl. CPC G06F 16/93; G06F 16/3349; G06N 20/00

(57) ABSTRACT

A system includes a storage device and a plurality of processing nodes in communication with the storage device. At least one processing node of the plurality of processing nodes receives query history. The query history contains information on a plurality of executed queries. The at least one processing node generates, using a large language model (“LLM”), a document for each query describing the information associated with a respective query. The at least one processing node divides generated documents into a plurality of groups. The at least one processing node compresses the documents to reduce a number of documents in each group until a predetermined threshold is reached. The at least one processing node stores a final compressed set of workload documents. The at least one processing node performs workload analysis using workloads described in the final compressed set of workload documents. A method and computer-readable medium are also disclosed.

### BACKGROUND

A fundamental prerequisite to understanding database system usage is an in-depth analysis of workloads whose database language text, execution plans, and resource usage metrics can be collected with a query logging mechanism. Although such analyses can be attempted by a human database administrator (“DBA”), many database vendors offer automated services or tools that assist with this complex task. One prominent category are tools that analyze workloads and make tuning recommendations, but unfortunately, they often do not scale to very large workloads typical of enterprise customers. In addition, automated tuning tasks operating within cloud multi-tenant services may be responsible for analyzing thousands of individual workloads. The designers of such workload analysis tools rightly concluded that an effective solution to this scalability challenge was to first compress the workload(s) into smaller query sets whose characteristics were still representative of the whole.

Another popular use case for workload compression is the generation of benchmarks that can reliably predict the performance of a much larger workload. Such benchmarks are useful when conducting proof of concepts (“POCs”) for large customer workloads and for development operations regression testing. Unlike industry standard benchmarks such as TPC-H that are manually designed and generated once, this use case often requires a benchmark to be generated for each customer or test suite.

Existing methods for performing workload compression include variants of K-Medoid clustering with specially designed distance functions for queries and machine learning models that vectorize and plot queries. These methods often require adjustments or retraining for individual workloads and suffer from scalability issues themselves, which in turn defeats their original purpose. In contrast, the clustering capabilities offered by modern large language models (“LLMs”) offer dramatic improvements in general applicability and efficiency as evidenced in their growing popularity with natural language processing (“NLP”) tasks such as topic modeling.

While LLMs can provide a powerful tool in database analytics, some limitations remain. LLMs must be trained in a manner that allows them to accurately process information give. This also requires that the information to be processed be structured in a manner understandable by an LLM. Moreover, LLMs have token limits that requires judicious selection of inputs that may reduce the LLMs capacity for precision.

Because traditional LLMs are limited by input limitations, it would be desirable to design inputs to allow an LLM to have a more expansive input set to make workload compression decisions.

### SUMMARY

According to one aspect of the disclosure, a system may include a storage device. The system may further include a plurality of processing nodes in communication with the storage device. At least one processing node of the plurality of processing nodes may receive query history. The query history may contain information on a plurality of executed queries. The at least one processing node may generate, with a large language model (“LLM”), a document for each query describing the information associated with a respective query. The at least one processing node may divide generated documents into a plurality of groups. The at least one processing node may compress the documents to reduce a number of documents in each group until a predetermined threshold is reached. The at least one processing node may store a final compressed set of workload documents. The at least one processing node may perform workload analysis using workloads described in the final compressed set of workload documents.

According to another aspect of the disclosure, a method may include receiving, with a processor, query history. The query history may contain information on a plurality of executed queries. The method may further include generating, with the processor, with an LLM, a document for each query describing the information associated with a respective query. The method may further include dividing, with the processor, generated documents into a plurality of groups. The method may further include compressing, with the processor, the documents to reduce a number of documents in each group until a predetermined threshold is reached. The method may further include storing, with the processor, a final compressed set of workload documents. The method may further include performing, with the processor, workload analysis using workloads described in the final compressed set of workload documents.

According to another aspect of the disclosure, a computer-readable medium may be encoded with a plurality of instructions executable by a processor. The plurality of instructions may include instructions to receive query history. The query history may contain information on a plurality of executed queries. The plurality of instructions may include instructions to generate, with an LLM, a document for each query describing the information associated with a respective query. The plurality of instructions may include instructions to divide generated documents into a plurality of groups. The plurality of instructions may include instructions to compress the documents to reduce a number of documents in each group until a predetermined threshold is reached. The plurality of instructions may include instructions to store a final compressed set of workload documents. The plurality of instructions may include instructions to perform workload analysis using workloads described in the final compressed set of workload documents.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is an example of workload compression.

FIG. 6 is a block diagram of an example system implementing a large language model to perform workload compression.

FIG. 7 is an example of a workload documents.

FIG. 8 is an example of a prompt template.

FIG. 9 is an example of a technique to generate an input set for workload compression.

FIG. 10 is an example of database workload service.

FIG. 11 is an operational flow diagram of a database workload service.

### DETAILED DESCRIPTION OF THE FIGURES

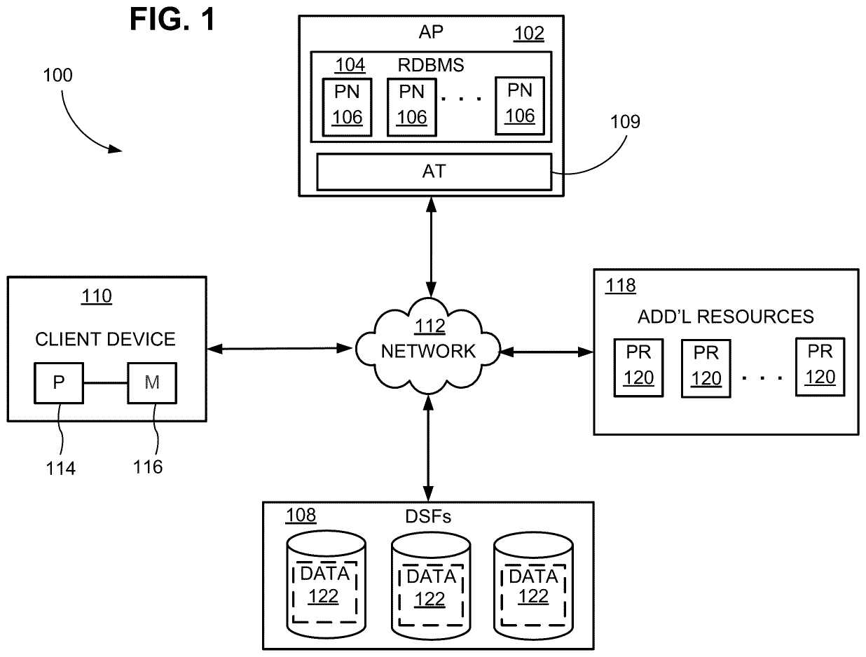

FIG. 1 is a block diagram of an example analytic environment 100. In one example, the analytic environment 100 may include an analytic platform (“AP”) 102, such as Teradata Vantage. The analytic platform 102 may include one or more systems that may be used independently or with one another in conducting advanced analytics. The analytic platform 102 may include a relational database management system (“RDBMS”) 104. In one example, the RDBMS 104 may implement a parallel-processing environment to conduct database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The DSFs 108 may represent various types of storage, such as persistent and/or non-persistent, for example. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, and/or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

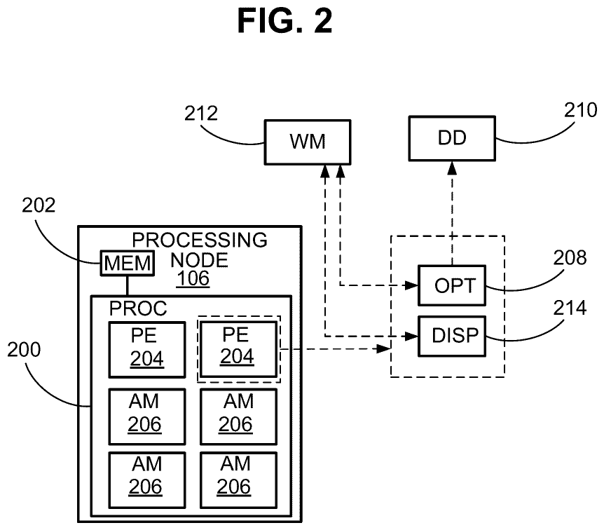

FIG. 2 is an example of a processing node 106, which may include one or more physical processors 200 and memory (ies) 202. Memory (ies) 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, which includes instructions executable with the processor 200 or other processor to implement one or more of the features of the module. When any one of the modules includes the portion of the memory 202 that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Vantage analytic platform, for example.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIGS. 1-2, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 104 stores data 122 in one or more tables (or other data object formats) in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

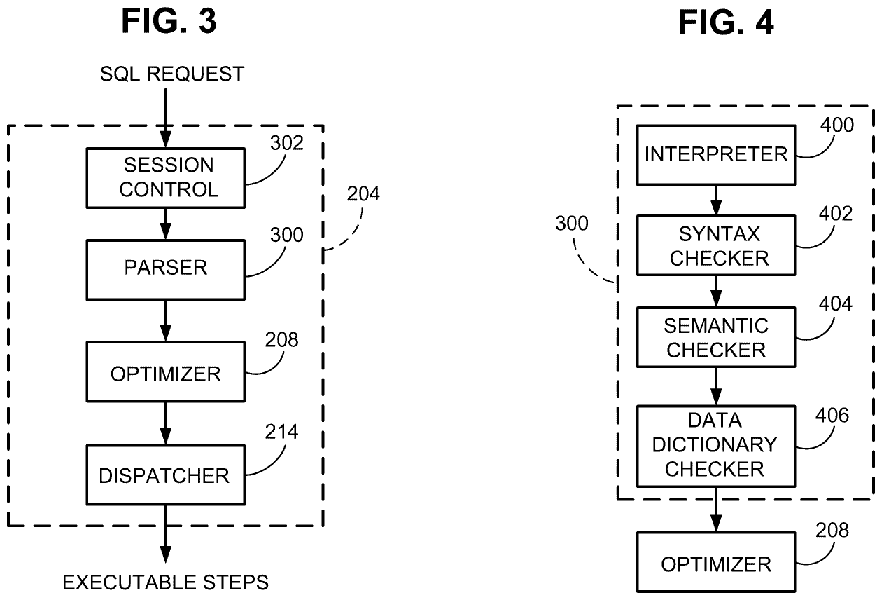

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 204 for purposes of illustration.

The data dictionary module 210, which may reside in the RDBMS 104, may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212, which may be executed within the RDBMS 104 by one or more processing nodes 106. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission the client device 110 and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

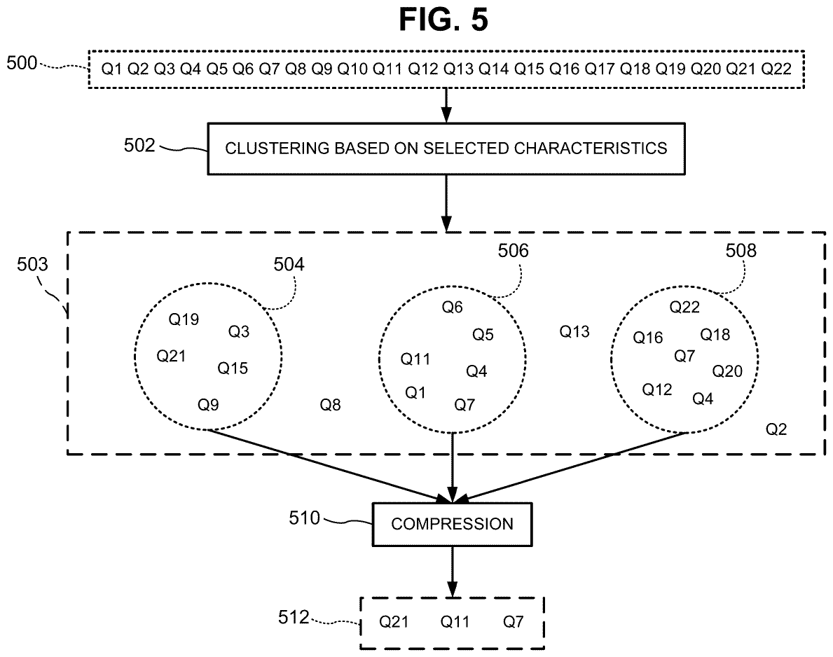

AI-driven techniques may be implemented in the analytic platform 102 allowing more advanced workload compression techniques to be handled by large language models (“LLMs”). FIG. 5 is an example of workload compression to illustrate how an LLM may be used to conduct compression for purposes of allowing various workload-related analyses to be performed downstream. In the example of FIG. 5, a query set 500 may contain queries Q1 through Q22. One technique in compressing workloads may include clustering queries based on selected characteristics. Queries can be related in a number of manners, what may include, but not be limited to, data (e.g., tables) being accessed, query source, storage type, and query type. In the example of FIG. 5, queries from the query set 500 may undergo clustering 502 based on some predetermined selected characteristic(s), which generates clustering results 503 that includes three query clusters 504, 506, and 508. Queries Q2, Q8, and Q13 are outliers based on the selected characteristic(s) with respect to the query set 500. The clusters 504, 506, and 508 may undergo compression 510 in that a query representative of a respective cluster may be selected for analysis. In the example of FIG. 5, queries Q7, Q11, and Q21 are selected as a representative query from their respective clusters. Such compression allows analyses to be performed without the need to consume massive amounts of query data, which typical systems cannot handle to scale.

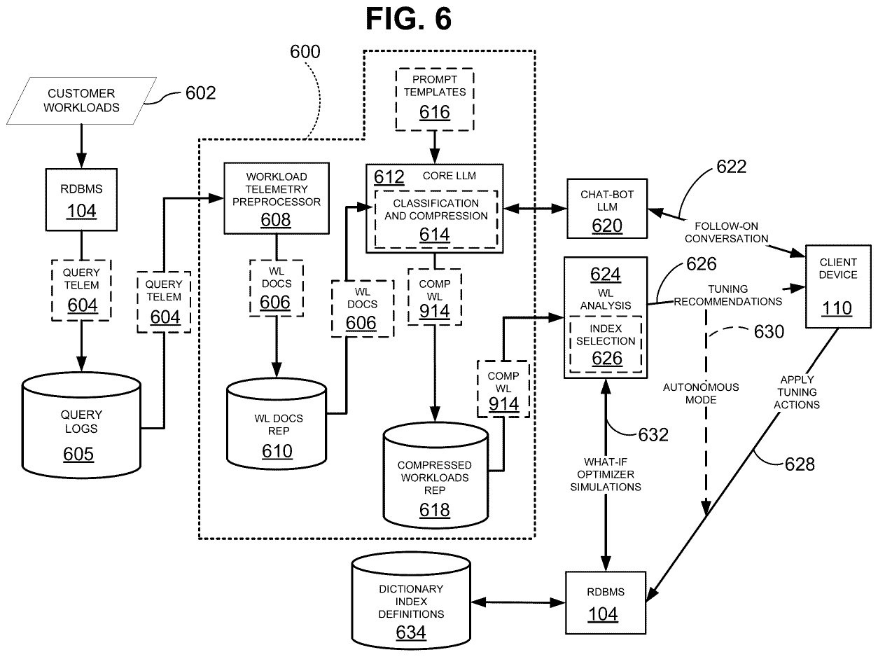

Using these compression techniques, LLMs may be implemented in a manner that can execute compression allowing more precise results to be generated enhancing downstream analyses and applications. FIG. 6 is an example of a system 600 that may be executed in an analytic environment that includes a database management system, such as RDBMS 104, allowing LLMs to handle workload compression. In one example, customer workloads 602 may be executed by the RDBMS 104, where each customer workload 602 may include one or more queries. The RDBMS 104 may log received queries in which query telemetry 604 is collected in query logs 605. The query telemetry 604 may include various types of metadata associated with a query.

As described, LLMs may be used in the handling of workload compression. However, in order for an LLM to be able to handle workload compression, the LLM must receive query information in manner that can be processed by the LLM. For example, information in natural language format allows modern LLMs to process the information. Query telemetry 604 is raw database data, which may reside in different formats and storage types. The query telemetry 604 may also provide additional raw data beyond the query syntax itself, such as the execution plan chosen by the optimizer 208 and runtime metrics. The query telemetry 604 needs to be converted to a text-based representation allowing an LLM to perform workload compression. In one example, a workload telemetry preprocessor module 608 may generate text-based documents based on the query telemetry 604. Specifically, the workload telemetry preprocessor module 608 may generate a workload document 606 for each received query based on the query telemetry 604, with the workload documents 606 maintained in a workload document repository 610. Table 1 below is an example of categories that the telemetry 604 may be organized into and used as standard subsections in each workload document 606 to facility natural language processing (“NLP”) by an LLM.

TABLE 1
Categories of Query Metadata

| Document Subsections | Description/Purpose |
|---|---|
| SQL text | Statement type, objects referenced, analytic functions, and filtering |
| | conditions |
| Plan text (EXPLAIN) | Natural language summary of execution plan steps, physical |
| | operators, and access methods |
| Scheduling | WLM assigned priority tier and selected compute cluster types |
| Resource Usage | Runtime metrics including CPU, I/O, memory, spool, and network |
| Latency | Response time and Service Level Goal adherence |
| Object metadata | Critical portions of object definitions needed for query clustering |

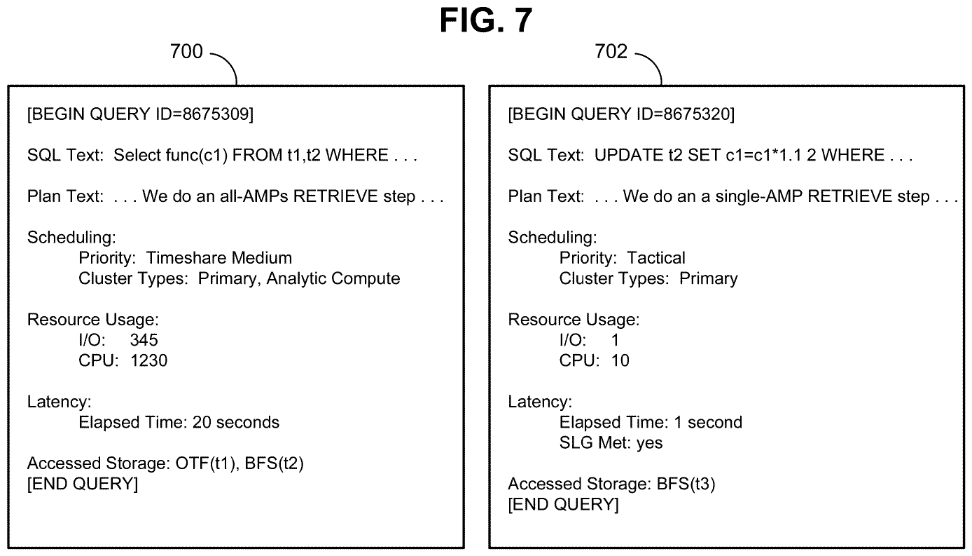

Referring to FIG. 7, an example of workload documents are presented to illustrate how the workload documents may be structured. In one example, workload documents 700 and 702 illustrate the types of information that may be used in a workload document. Regarding workload document 700, a query record (“QUERY ID”) may be identified. The workload document 700 may also contain a SQL text category of the query and plan text (via the EXPLAIN feature) category. The SQL and EXPLAIN categories provide the names of referenced objects (e.g., tables and columns), which is generally sufficient for query clustering without having to include detailed schema definitions. If included in its entirety, the extra content would bloat the size of the workload documents and exacerbate the limits on LLM context windows. Workload analysis operations running after compression may require such metadata but can retrieve it from the data dictionary 210 as needed. Even so, this solution recognizes that certain portions of object metadata may be relevant to clustering and reserves a category (“accessed storage”) for them. A prominent example is the underlying storage types of tables referenced (e.g., block storage, open table format, parquet files), with each type supporting dramatically different access methods and performance profiles. While EXPLAIN text may differ somewhat for steps accessing different storage types, a separate subsection in each workload document 606 is included to emphasize its importance in deciding how to cluster similar queries.

As shown in workload document 700, categories for “scheduling”, “resource usage” and “latency” may also be included. Workload document 702 includes the same subsection categories as workload document 700, but contains different information regarding the associated query (query id=8675320)

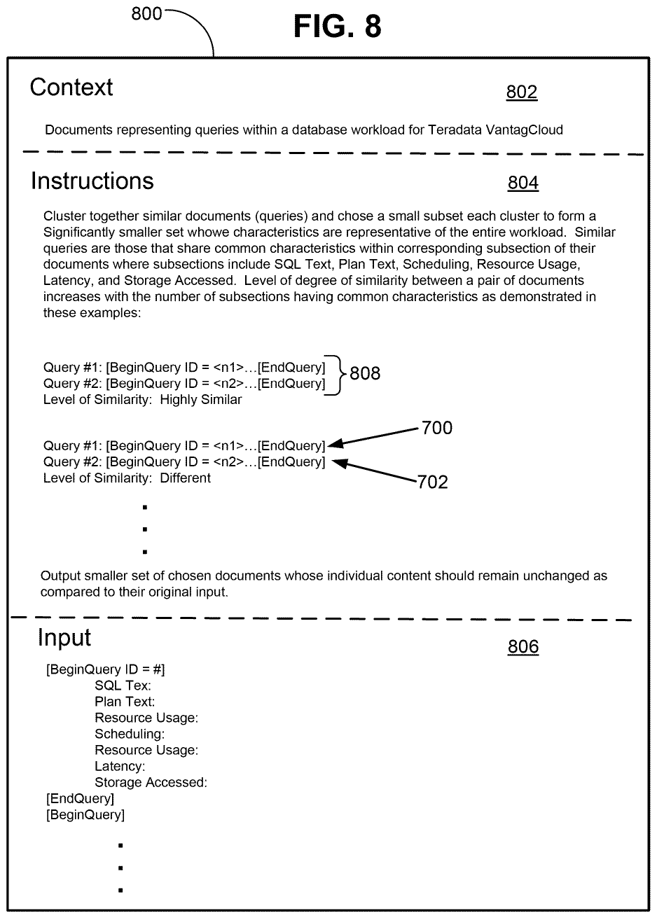

Returning to FIG. 6, once the workload documents 606 have been generated, they may be provided to a core LLM 612, which may include a classification and compression module 614, which both classifies and compresses workloads using the workload documents 606. In order to assist in the understanding the workload documents 606, prompt templates 616 may be used to provide guidance to the LLM 612, both with respect to the content of each workload document and comparison of the content across the workload documents 606. FIG. 8 is an example of a prompt template 800 that may be provided to the core LLM 612. As shown in FIG. 8, prompt template 800 may include a context section 802 giving context of the task to the LLM 612. The context section may include not only context to databases, also to specific systems (e.g., Teradata VantageCloud). The prompt template 800 may also include an instructions section 804. The instructions section 804 provides instructions to the LLM 612 on what to do with the workload documents 606. In particular, the instructions provide the goal of the LLM, as well as describe the structure of the workload documents 606. In order to further assist the LLM 612, the prompt template 800 may include examples of workload documents describing queries with similar characteristics and queries having different characteristics. In the example prompt template 800, sample workload documents 808 are included in the prompt template 800 having similarities such that LLM 612 may understand queries of this degree of similarity are considered “highly similar”. In the example of FIG. 8, the workload documents 700 and 702 are used as two queries considered to be “different”. The prompt template 800 may be tailored to include as many sample workload documents within the limits of input of the context window of the LLM 612. Lastly, the prompt template 800 may include an input section 806. The input section may include all of the workload documents 606 representing queries to be considered in workload compression.

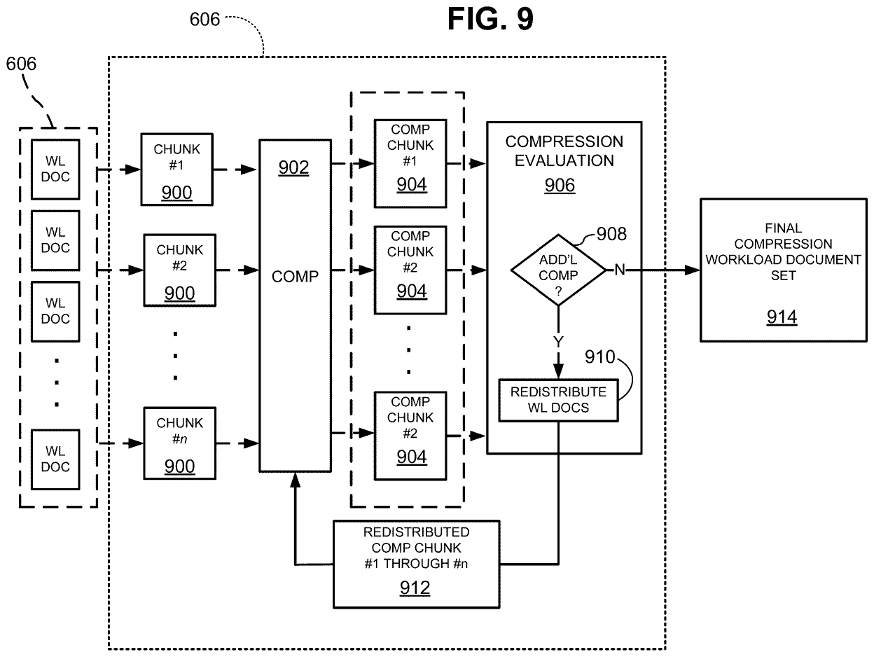

Using the prompt template 800, the LLM 612 may perform workload compression using the available workload documents 606. Each LLM has a limit on the number of tokens that it can receive as input. Thus, if the number of total workload documents 606 exceeds this limit, the number of workloads 606 may be broken up to allow the LLM 612 to perform the workload compression. An example of this technique is shown in FIG. 9. In one example, the workload documents 606 may be broken into n chunks 900 with each chunk 900 representing a number T of the workload documents 606. The number T represents a minimum threshold of information to provide meaningful query clustering for the compression. In scenarios in which the combined size of T workload documents 606 is too large, the SQL and EXPLAIN text portions of the workload documents 505 may be truncated, as necessary. Each chunk 900 may undergo compression 902 by the core LLM 612 in accordance with the guidance provided by the prompt templates 800 resulting in a compressed chunk 904. A compression evaluation 906 may be performed on the compressed chunks 904. The evaluation 906 may include an additional compression determination 908 to determine if additional compression is needed based on the intermediate chunks being too large. If additional compression is needed, redistribution 910 of the workloads 606 may be performed by randomly redistributing the workloads 606 of the compressed chunks 904 into n chunks. This process may occur iteratively until the size of the chunks 904 are small enough to be collectively handled by the LLM 612. Once additional compression is no longer needed (determination 908), the final compression results 914 that includes final compressed chunks 916.

Referring back to FIG. 6, once the final compressed workloads 914 are generated, they may be retained in a compressed workload repository 618. With the compressed workloads a number of analyses may be performed as illustrated in FIG. 6. In one example, the analytic platform 102 may include a chat-bot LLM 620 allowing follow-on conversations 622 to be performed between a user via client device 110 and the chat-bot LLM 620. The compressed workloads 914 may be used to perform workload analysis 624. The workload analysis 624 may provide tuning recommendations 626 to the user via the client device 110, which may be applied as tuning actions 628 by a user via client device 110 to the RDBMS 104. In an autonomous mode 630, tuning actions 630 based on the recommendations 626 may be automatically applied to the RDBMS 104.

The RDBMS 104 may also implement the compressed workloads 914 for index selection 632 to execute “what-if” simulations 634 using the optimizer 208 (not shown) of the RDBMS 104 and dictionary index definitions 634 to recommend indices and materialized views for the purpose of improving performance which is generally referred to as “index selection”. An established and accurate method for performing index selection involves a series of “what-if” simulations on the potentially large space of alternative index configurations. Each simulation requires calling the optimizer 208 to estimate the benefit of the candidate index configuration for each retrieval query in the workload and the added maintenance overhead for each update statement. More recent solutions for index selection involve the use of deep learning that require the use of a reward function to observe the benefit from applying a given tuning action. In the case of uncompressed large workloads, the time required to compute the reward would make this trial-and-error learning approach impractical.

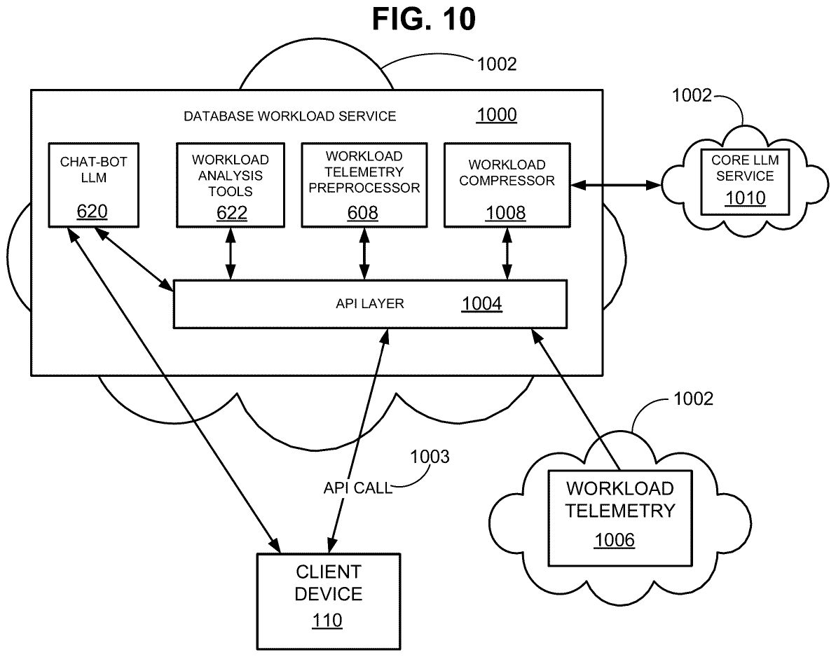

FIG. 10 is an example of a cloud-service-based version of a workload compressor as seen in FIG. 6 using an LLM. In one example, a database workload service 1000 may act as a cloud-based service independent of the RDBMS 104 operating over cloud network 1002. In operation, a user via client device 110 may access the features of the database workload service 1000 via an application programming interface (“API”) layer 1004 through cloud-network 1002 with an API call 1003. Alternatively, the chat-bot LLM 620 may be used to allow user interactions, however the chat-bot LLM 620 operates through the API layer 1004.

In operation, the client device 110 may initiate the database workload service 1000, which may retrieve workload telemetry 1006, which may include query logs 605 containing individual query telemetry 604 included in various workloads. The workload telemetry preprocessor module 608 may generate the workload documents 606 that may be compressed by the workload compressor 1008. In one example, the workload compressor 1008 may implement a third-party core LLM service 1010 via cloud network 1002, similar in functionality to the core LLM 612 and may handle the compression of the workloads via the techniques described with regard to FIG. 9. Workload analysis tools 622 may be used in either a manual fashion via the client device 110 or through autonomous techniques.

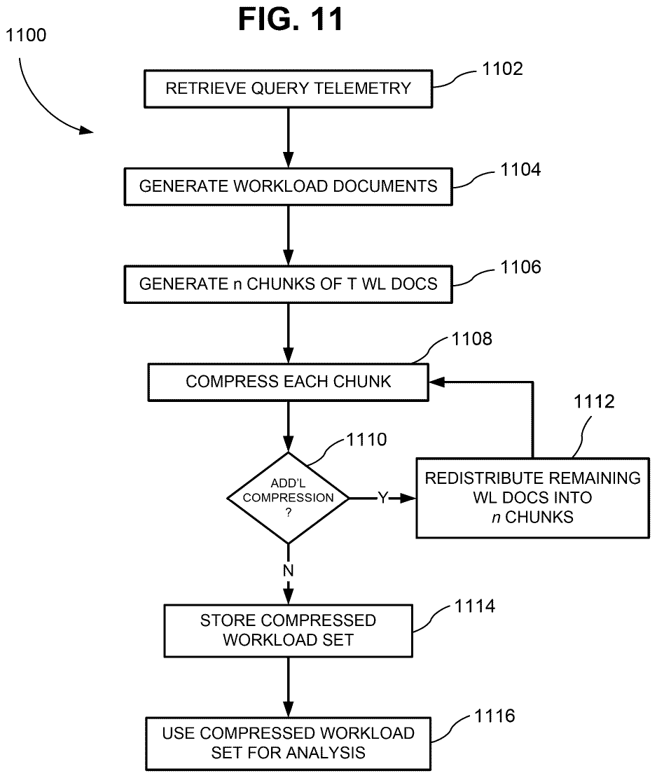

FIG. 11 is an operational flow diagram 1100 of example operation of workload compression via an LLM. In one example, query telemetry 604 may be retrieved by the workload telemetry preprocessor 608 (1102). A workload document 606 may be generated for each query described in the query telemetry 604 (1104). The workload documents 606 may be divided into n chunks 900 with each chunk containing at least T workload documents 606 (1106). Each chunk 900 may be compressed (1108). If additional compression is needed (1110), the compressed chunks 904 may be redistributed (1112) and again compressed (1108). Once additional compression is no longer needed (1110), the compressed workload set 914 may be stored for analysis (1114). The compressed workload set 915 may be used for workload analysis (1116).

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

1. A system comprising:
a storage device comprising one or more data storage facilities comprising computer-readable storage media;
a plurality of processing nodes in communication with the storage device, wherein each processing node includes one or more processors and memories comprising instructions executable by the one or more physical processors, and wherein at least one processing node from the plurality of processing nodes is configured to:
receive query history indicative of queries executed by a database management system, wherein the query history contains query telemetry collected in query logs and contains information on a plurality of executed queries;
generate a workload document for each query describing the information associated with a respective query based on the query telemetry wherein the workload document comprises a text-based representation of the query telemetry;
divide generated workload documents into a plurality of groups;
compress, with a large language model (“LLM”), the workload documents to reduce a number of documents in each group until a predetermined threshold is reached, wherein the predetermined threshold is a maximum amount of information that can be handled by the LLM, and wherein compression may include eliminating an amount of documents based on a set of parameters employed by the LLM;
store a final compressed set of workload documents; and
perform workload analysis using workloads described in the final compressed set of workload documents.

2. The system of claim 1, wherein the at least one processing node is configured to generate each workload document to include database syntax language and query plan text generated via database syntax command.

3. The system of claim 1, wherein the at least one processing node is further configured to:
divide the generated workload documents into chunks with each chunk containing at least T workload documents, wherein T is a minimum threshold of information to provide meaningful query clustering; and
compress, with the LLM, each chunk to generate a compressed chunk, wherein, in scenarios in which a combined size of T workload documents is too large, text portions of the workload documents are truncated, as necessary, and wherein a compression evaluation is performed on the compressed chunks and includes an additional compression determination to determine if additional compression is needed based on the intermediate chunks being too large, and wherein, when additional compression is needed, redistribution of the workload documents of the compressed chunks is performed by randomly redistributing the workload documents of the compressed chunks into n chunks and again compressing each chunk, iteratively, until sizes of the compressed chunks are small enough to be collectively handled by the LLM.

4. The system of claim 1, wherein the at least one processing node is further configured to generate a prompt template to provide instructions to the LLM on processing each workload document.

5. The system of claim 1, wherein at least one processing node performs index selection for the database management system.

6. A method comprising:
receiving, with a processor, query history indicative of queries executed by a database management system, wherein the query history contains query telemetry collected in query logs and contains information on a plurality of executed queries;
generating, with the processor, a workload document for each query describing the information associated with a respective query based on the query telemetry, wherein the workload document comprises a text-based representation of the query telemetry;
dividing, with the processor, generated workload documents into a plurality of groups;
compressing, with a large language model (“LLM”) executed by the processor, the workload documents to reduce a number of documents in each group until a predetermined threshold is reached, wherein the predetermined threshold is a maximum amount of information that can be handled by the LLM, and wherein compression may include eliminating an amount of documents based on a set of parameters employed by the LLM;
storing, with the processor, a final compressed set of workload documents; and
performing, with the processor, workload analysis using workloads described in the final compressed set of workload documents.

7. The method of claim 6, wherein generating, with the processor, a workload document comprises generating, with the processor, each workload document to include database syntax language and query plan text generated via database syntax command.

8. The method of claim 6, wherein:
the dividing comprises dividing, with the processor, the generated workload documents into chunks with each chunk containing at least T workload documents, wherein T is a minimum threshold of information to provide meaningful query clustering; and
the compressing comprises compressing, with the LLM executed by the processor, each chunk to generate a compressed chunk, wherein, in scenarios in which a combined size of T workload documents is too large, text portions of the workload documents are truncated, as necessary, and wherein a compression evaluation is performed on the compressed chunks and includes an additional compression determination to determine if additional compression is needed based on the intermediate chunks being too large, and wherein, when additional compression is needed, redistribution of the workload documents of the compressed chunks is performed by randomly redistributing the workload documents of the compressed chunks into n chunks and again compressing each chunk, iteratively, until sizes of the compressed chunks are small enough to be collectively handled by the LLM.

9. The method of claim 6, further comprising generating, with the processor, a prompt template to provide instructions to the LLM on processing each workload document.

10. The method of claim 6, the method further comprising performing, with the processor, index selection for the database management system.

11. A non-transitory computer-readable medium encoded with a plurality of instructions executable by a processor, the plurality of instructions comprising:
instructions to receive query history indicative of queries executed by a database management system, wherein the query history contains query telemetry collected in query logs and contains information on a plurality of executed queries;
instructions to generate a workload document for each query describing the information associated with a respective query based on the query telemetry, wherein the workload document comprises a text-based representation of the query telemetry;
instructions to divide generated workload documents into a plurality of groups;
instructions to compress, with a large language model (“LLM”), the workload documents to reduce a number of documents in each group until a predetermined threshold is reached, wherein the predetermined threshold is a maximum amount of information that can be handled by the LLM, and wherein compression may include eliminating an amount of documents based on a set of parameters employed by the LLM;
instructions to store a final compressed set of workload documents; and
instructions to perform workload analysis using workloads described in the final compressed set of workload documents.

12. The non-transitory computer-readable medium of claim 11, the instructions to generate a workload document comprise instructions to generate each workload document to include database syntax language and query plan text generated via database syntax command.

13. The non-transitory computer-readable medium of claim 11, wherein:
the instructions to divide comprises instructions to divide the generated workload documents into chunks with each chunk containing at least T workload documents, wherein T is a minimum threshold of information to provide meaningful query clustering; and
the instructions to compress comprises instructions to compress, with the LLM, each chunk to generate a compressed chunk, wherein, in scenarios in which a combined size of T workload documents is too large, text portions of the workload documents are truncated, as necessary, and wherein a compression evaluation is performed on the compressed chunks and includes an additional compression determination to determine if additional compression is needed based on the intermediate chunks being too large, and wherein, when additional compression is needed, redistribution of the workload documents of the compressed chunks is performed by randomly redistributing the workload documents of the compressed chunks into n chunks and again compressing each chunk, iteratively, until sizes of the compressed chunks are small enough to be collectively handled by the LLM.

14. The non-transitory computer-readable medium of claim 11, the plurality of instructions further comprising instructions to generate a prompt template to provide instructions to the LLM on processing each workload document.

15. The non-transitory computer-readable medium of claim 11, the plurality of instructions further comprising instructions to perform index selection for the database management system.
